(19) United States
(12) Patent Application Publication
(10) Pub. No.: US 2006/0192317 A1
(43) Pub. Date: Aug. 31, 2006

(54) Method and apparatus for drying coated sheet material

(76) Inventors: Jack E. Paulson, Pittsford, NY (US); Wayne C. Griffin, Livonia, NY (US); William J. Gamble, Rochester, NY (US)

Correspondence Address: Paul A. Leipold;Patent Legal Staff, Eastman Kodak Company, 343 State Street, Rochester, NY, 14650-2201, US

(21) Appl. No.: 11/066,785

(22) Filed: Feb. 25, 2005

(51) Int. Cl. B29C 39/14

(52) U.S. Cl. 264/216; 264/217; 425/224; 425/75

(57) ABSTRACT

Apparati and methods of drying a dope material are disclosed. Example embodiments include a foraminous shield disposed over a casting solution.

### BACKGROUND

Light-valves are implemented in a wide variety of display technologies. For example, microdisplay panels are gaining in popularity in many applications such as televisions, computer monitors, point of sale displays, personal digital assistants and electronic cinema to mention only a few applications.

Many light valves are based on liquid crystal (LC) technologies. Some of the LC technologies are prefaced on transmittance of the light through the LC device (panel), while others are prefaced on the light's traversing the panel twice, after being reflected at a far surface of the panel.

An external electric field is used to selectively rotate the axes of the liquid crystal molecules. As is well known, by application of a voltage across the LC panel, the direction of the LC molecules can be controlled and the state of polarization of the transmitted light may be selectively changed. As such, by selective switching the transistors in the array, the LC medium can be used to modulate the light with image information. Often, this modulation provides dark-state light at certain picture elements (pixels) and bright-state light at others, where the polarization state governs the state of the light. Thereby, an image is created on a screen by the selective polarization transformation by the LC panel and optics to form the image or ‘picture.’

As is known, the light source (often referred to as a backlight unit) for the display is a source of substantially white light. The light from the source may be incident on a light management film. Light management films are often used in light-valve based displays to modify and to control the distribution of light emitted from a backlight unit.

Cast polymer materials may be used for light management films in display applications as well as other optical applications. However, in order to be implemented in optical applications, the thickness and surface properties of the cast polymer must be substantially uniform. To wit, variations in the thickness of the polymer layer and irregularities in the surface of the layer can have a deleterious impact on the optical properties of the light management layer. As such, fabricating the cast polymer materials for use in display and other applications where uniformity in thickness and surface properties of the material are important considerations, has garnered significant interest.

In the forming of a solvent cast polymer sheet, such as a sheet of cellulose triacetate (TAC), it is a common practice to utilize a drying apparatus in which a gaseous drying medium (often air or nitrogen that has been heated to a suitable elevated temperature) is brought into direct contact with the exposed drying layer of the supported sheet in order to effect evaporation of the liquid medium (e.g., solvent) from the layer. In such driers, the gaseous drying medium is directed so as to be distributed uniformly over the surface of the coating under carefully controlled conditions that are ideally to result in a minimum amount of disturbance of the layer. A common type of drier utilizes a plenum into which the gaseous drying medium is admitted and from which the gaseous drying medium is discharged onto the surface of the layer, which is to be dried.

In the operation of such driers, the sheet material, which is initially in the form of a layer of casting solution on a casting surface, is continuously conveyed through the drier along a predetermined path. The gaseous drying medium becomes laden with vapor evaporated from the layer of casting solution. As the casting solution travels through the drier, the gaseous drying medium is directed from the plenum onto the drying surface and the spent medium flows away from the path of travel to be discharged.

Unfortunately, during the drying of casting solutions, thickness irregularity in the sheet may occur. As mentioned, beyond certain threshold limits, these irregularities can have a deleterious impact on the optical performance of the polymer sheet.

One source of variations in thickness in the polymer sheet is non-uniform drying of the casting solution. For example, turbulent airflow within the gaseous drying medium can result in physical disturbance of the drying skin layer that manifests itself as short-range thickness variation (S.R.T.V.) in the dried product. Also, non-uniform temperatures in the drying medium, non-uniform heat transfer rates across the drying region, and non-uniform vapor concentration in the gaseous drying medium, individually or in combination can lead to non-uniform rates of removal/evaporation of the liquid medium of the casting solution at different points across the surface of the layer. This non-uniform removal of the liquid medium can result in stresses in the casting liquid that cause non-uniformities in the thickness of the material as well as surface irregularities in the material.

Certain attempts have been made to address the irregularities in the thickness of cast polymer sheets. One technique includes providing relatively high concentrations of the solvent, which retards the drying rate. This prevents, inter alia, the formation of a relatively hard surface skin over the casting solution, and ultimately the attendant variations in the thickness of the layer. While the use of high solvent concentrations retards the drying rate, this technique poses significant drawbacks. One such drawback is manufacturing safety. To wit, in order to provide high concentrations of solvent, oxygen must be substantially absent from the process in order to avoid explosions. Thus an inert gas must be introduced. Commonly, nitrogen gas is used in this capacity. While nitrogen beneficially is not explosive in the presence of the solvent, this gas must be handled with extreme care as it can prevent respiration in human beings. Thus, the hazardous nature of this technique makes this an unattractive option.

Another technique used to improve thickness uniformity of the cast sheets of polymer is employed after the sheet is cast. This technique includes stretching on a tentering apparatus. While stretching the cast sheet, the cast sheet may provide acceptably uniform thickness, the tentering apparatus is complex and there is waste around the peripherae of the sheet where the sheet is grasped. This waste and the complexity of the tentering apparatus make this an unattractive option.

What is needed therefore is a method of fabricating a cast polymer material and an apparatus for drying the casting solution that provides a substantially uniformly thick layer, while overcoming at least the shortfalls of the known methods and apparati described previously.

### DEFINED TERMINOLOGY

In addition to their ordinary meaning and in the context of the example embodiments described herein, the following terms are defined presently. It is emphasized that the terms provided are intended merely to compliment or supplement their ordinary meaning, and thus are not limiting.

Casting solution—a material disposed over a casting surface and before it is removed.

Web—a material that has been removed from the casting surface.

It is again emphasized that the referenced terminology is included for complement or supplement of the ordinary meaning of each term; and in no way limits the any example embodiment, which includes features described by one or more of the referenced terms.

### SUMMARY

In accordance with an example embodiment, a method of drying a casting solution includes advancing the casting solution in an opposed closely spaced relationship with a foraminous shield, which is substantially permeable to a gaseous drying medium. A solvent vapor concentration above a surface of the casting solution is slightly less than a solvent vapor-liquid equilibrium concentration at a surface of the casting solution.

In accordance with another example embodiment, an apparatus for drying a dope material includes a casting surface, which is adapted to have a casting solution disposed thereover. The apparatus also includes a foraminous shield disposed over the casting solution.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Moreover, like reference numerals refer to like features throughout.

FIG. 1 is a cross-sectional view of a casting apparatus in accordance with an example embodiment.

FIG. 2 is a cross-sectional view of a section of a casting apparatus in accordance with an example embodiment;

FIG. 3a is another cross-sectional view of the casting section of FIG. 2;

FIG. 3b is an enlarged view of a portion of FIG. 3a;

FIG. 4a is a cross-sectional view of a foraminous screen along the width of the screen in accordance with an example embodiment;

FIG. 4b is a cross-sectional view of a foraminous screen comprising a plurality of layers along the width of the screen in accordance with an example embodiment;

FIG. 4c is a cross-sectional view of the foraminous screen of FIG. 4a along the line 4a-4a in accordance with an example embodiment;

FIG. 4d is a top view of a foraminous screen in accordance with an example embodiment;

FIGS. 5a and 5b are graphical representations comparing the thickness variation of a section of a layer formed in accordance with an example embodiment and the thickness variation of a known layer; and

FIG. 6 is a cross-sectional view of a casting apparatus in accordance with an example embodiment.

### DETAILED DESCRIPTION

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known apparati and methods may be omitted so as to not obscure the description of the example embodiments. Such methods and apparati are clearly within the contemplation of the inventors in carrying out the example embodiments.

Notably, illustrative embodiments relate to the fabrication of polymer sheets useful in display application; for instance as cover for optical polarizers. It is emphasized that this is merely an illustrative use of the apparati and methods of the example embodiments. To this end, the apparati and methods can be advantageously employed in many processes, used in the manufacture of solvent cast, free-standing film products, in which a gaseous drying medium is utilized in the drying of a coated layer formed from a rapid drying defect prone coating composition and in which the formation of streaks, lines, or surface irregularity in the coating is of concern.

Briefly, the example embodiments relate to methods and apparati for drying casting solutions. An illustrative method includes advancing the casting solution in an opposed closely spaced relationship with a foraminous shield which is substantially permeable to a gaseous drying medium. During the advancing, a solvent vapor concentration above the surface of the casting solution is slightly less than a solvent vapor-liquid equilibrium concentration at a surface of the casting solution. This fosters the removal of the solvent from the casting solution in a substantially uniform manner. Beneficially, this results in the formation of a cast layer having a substantially uniform thickness upon removal of the solvent (drying).

As described in connection with example embodiments, operating near (but slightly below) the equilibrium concentration is a useful aspect of in the implementation of the apparati and methods of these example embodiments. Notably, when the concentration of solvent in the gas phase above the surface of the casting layer are substantially at equilibrium with the liquid phase, substantially no mass transfer will take place. By controlling the gas phase concentration of solvent to be slightly less than the equilibrium concentration, the rate of solvent removal from the system can be controlled to be below the rate at which the solvent moves from the bulk of the casting solution layer to the surface of the layer. This prevents the formation of a low solvent concentration skin that impedes solvent migration.

An illustrative apparatus for drying a dope material includes a belt, which is adapted to have a casting solution (also referred to herein as the coating layer) disposed thereover. The apparatus includes a substantially porous (foraminous) shield disposed over the casting solution. Beneficially, the pores of the shield are small enough to substantially prevent transient airflow through and between the surface of the casting layer and the shield; but not so fine that the shield acts as a barrier to extraction of the solvent. Moreover, the shield acts as a physical barrier that slows down the exchange of air from the drying chamber with solvent emerging from the casting solution. This provides a region above the surface of the casting layer that is relatively rich in solvent, which aids in preventing the formation of a surface skin. Such a surface skin can foster uneven drying of the casting solution, resulting in an undesirable uneven thickness of the cast layer.

Specific details will now be set forth with respect to example embodiments depicted in the attached drawings. It is noted that like reference numerals refer to like elements.

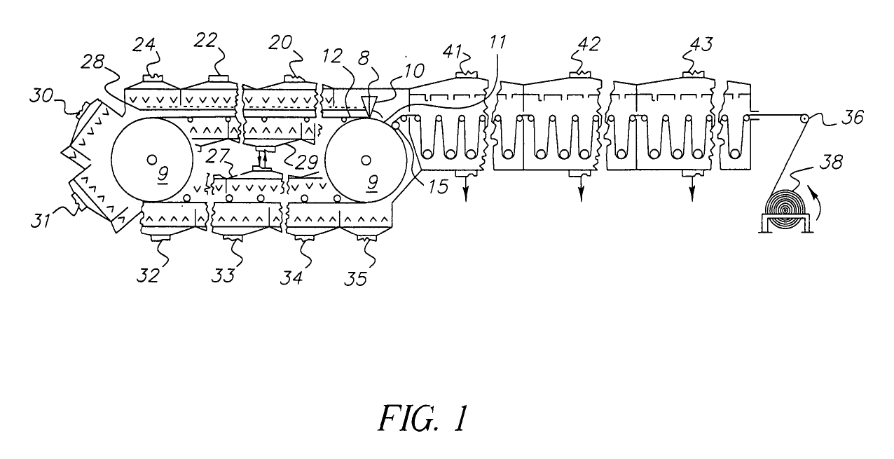

FIG. 1 schematically illustrates in cross-section an apparatus for drying a casting solution in accordance with an example embodiment. As shown in FIG. 1, sheet raw material is fed to the system as a pumped solvent and polymer solution 8, to form a continuous casting solution 12 from the polymer extrusion hopper 10. The carefully controlled sheet extrusion from the flat die is laid on a highly polished band 11, which form a casting surface. Illustratively, the band 11 is held in a substantially elliptical shape by two turning drums 9, one at each end and is supported in the flat sections by additional turning rollers. The high polish on the band is useful in providing good surface quality to the formed polymer sheet. The coating hopper 10 is typically enclosed within a baffled chamber in order to keep air movement from disturbing the extruded bead. Baffling around the extrusion hopper also prevents rapid drying of the solvent, which will prevent dried buildup on the hopper die lips.

After being coated on a frontside of the band 11, a layer or a plurality of layers of casting solution 12 passes as a drying polymer layer on the polished band 11 through a series of drying chambers 20, 22 and 24. The chambers 20, 22 and. 24 supply substantially warm dry air uniformly on the coated layer(s) (casting solution 12) to effect drying thereof. The chambers 20, 22, and 24 together define a first drying zone, and since this zone can comprise additional similar chambers to provide a sufficiently long path of travel for casting solution 12, the series of chambers is illustrated as being broken at several places. A foraminous shield 28, illustratively comprising a stainless steel screening, or a perforated plate is mounted in close proximity to the path of casting solution 12 and just above the surface thereof. The shield 28 extends throughout product side chambers 20, 22 and 24.

The band 11 and casting solution 12 move relatively rapidly through drying chamber 20 with the casting solution 12 spaced from, but in close proximity to, the opposing surface of stationary foraminous shield 28 to create a substantially quiescent zone. To wit, as described more fully herein there are substantially no turbulent airflow conditions between the foraminous shield 28 and the top of the casting solution 12. Moreover, the region beneath the shield 28 is relatively rich in the vapor resulting from evaporation of the liquid medium (e.g., solvent) in the casting solution 12.

After passing through the first drying zone defined by product side chambers 20, 22, and 24, casting solution 12 passes through a second drying zone defined by product side chambers 30, 31, 32, 33, 34, and 35. Since the second drying zone may comprise additional similar chambers to extend the path of travel of casting solution 12, this series of chambers is also illustrated as being broken at several places. Additional air heating systems may be disposed inside the oval of the band 11. To wit, heating airflow is directed at the interior of the highly polished casting band by plenums 27 and 29. This heating is another method to provide drying heat to overcome the heat of vaporization of the casting solvents. Multiple plenums can be used to achieve the band side heating. Moreover, the large turning drums 9 can also be heated, which in turn heat the band 11, to again provide a warm polished band which is conducive to solvent evaporation without providing a disturbing airflow near the drying polymer solution. Notably, the first drying zone functions to carry out the major portion of the drying of the coated layer (s).

As the casting solution 12 is dried, the sheet becomes consolidated enough to form a free-standing web. Stripping roller 15 is used to peel the support from the polished casting band. At this point the free web is approximately 30 weight percent to approximately 60 weight percent of the remaining casting solvents.

A third drying zone comprising chambers 41, 42 and 43 serves to remove additional amounts of the residual liquid medium remaining in the coated polymer sheet. As illustrated, the drying chambers in the first and second drying zones are of a flat-bed design while those in the third drying zone are of a traversing design in order to provide an extended residence time in each drying oven. After leaving the third drying zone, the web passes around guide roll 36 and is wound onto take-up roll 38.

Notably, the casting solution 12 drying on the band 11 (or casting surface) is conveyed along a horizontal or substantially horizontal path as shown in FIG. 1. However, under particular conditions, it may be desirable transport the casting solution 12 along a path which is inclined from the horizontal or along a path which is vertical. If desired, the drying apparatus can utilize a flat-bed design in an initial portion thereof, in which the foraminous shield is utilized. Alternatively, and as described more fully herein, the foraminious shield may be disposed over a curved casting surface.

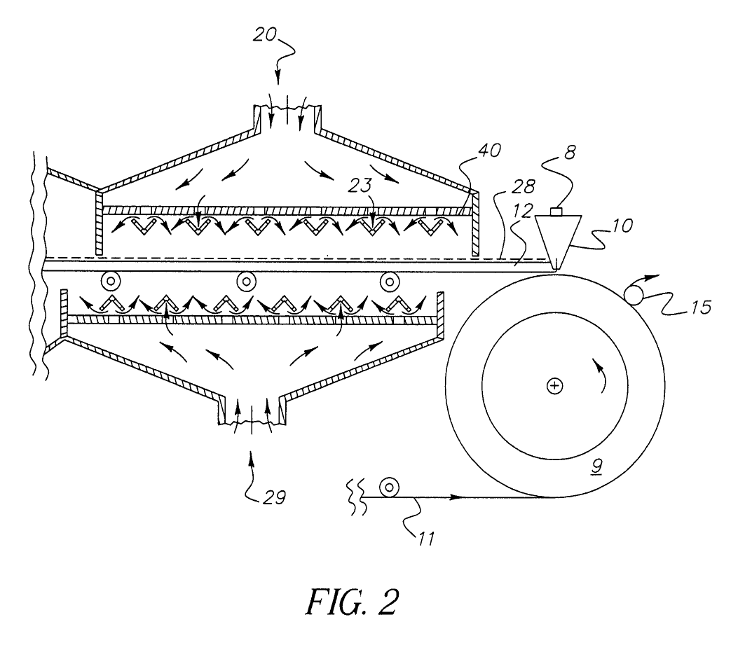

FIG. 2 is an enlarged view of drying chamber 20. FIG. 2 illustrates the flow path of the drying air in relation to foraminous shield 28. To wit, warm dry air (represented by arrows) is admitted to chamber 20 and passes through distributing plate 23. The distributing plate 23 provides a substantially uniform distribution of the air and significantly reduces the formation of air currents. Foraminous shield 28, which is comprised of screen elements or perforations, is substantially co-extensive in width with casting solution 12 and mounted in a position to be substantially parallel and closely adjacent to the casting solution 12. The mounting of shield 28 permits precise ‘up and down’ movement (i.e., movement substantially perpendicular to the movement of the band 11 and casting solution 12) so that it can be adjusted to set an optimum spacing in relation to casting solution 12.

As casting solution 12 travels through chamber 20 along a horizontal path defined by the surface of the polished band, a quiescent zone, which is rich in solvent vapor, is formed between the lower surface of screen element 28 and the upper surface of the casting solution 12. Spent gaseous drying medium flows transversely of the path of casting solution 12 in the region between perforated element 28 and distributing plate 23 and passes over the edges of casting solution 12 to exit from chamber 20 via exit ducts in the side walls of the machine casing. Within the quiescent solvent-rich zone between screen element 28 and the coated surface of casting solution 12, transverse flow of spent drying air is substantially suppressed and the establishment of substantially uniform heat transfer conditions is promoted. Beneficially, substantially laminar attachment of a rich solvent layer is provided under the foraminous shield. The motion of the drying sheet will attach the evaporated solvent flow and provide uniform drying conditions early in the casting process.

The foraminous shield 28 is usefully substantially permeable to the gaseous drying medium, and is positioned in opposed closely-spaced relationship with the coated surface of the casting solution 12. The foraminous shield 28 serves to promote flow of the spent gaseous drying medium adjacent to the surface of the shield 28 and to form a quiescent region between the shield 28 and the casting solution 12. This quiescent region is rich in the vapor of the liquid medium. Moreover, in the quiescent region the flow of the spent gaseous drying medium is significantly suppressed and uniform heat transfer and solvent vapor concentration conditions are promoted.

The foraminous shield 28 functions in several ways to reduce drying rate and drying rate non-uniformity. For example, the shield 28 functions to diffuse gas/air currents within the gaseous drying medium and thereby protect the casting solution 12 from turbulence which can cause physical disruption and deformation of the coated layer by impacting thereon. Notably, the casting solutions of the casting solution 12 contain volatile organic solvents. In order to reduce the hazards associated with the drying of such compositions, it is beneficial to introduce drying air into the drier at a relatively high volumetric flow rate so that the average concentration of solvent in the drier will be maintained at a low level. The need for very high volumetric flow rates results in a requirement for relatively high pressures in the plenum and, as a consequence, the drying air can travel across the surface of the layer of casting solution 12 at relatively high velocities which can disturb the casting solution 12. Under these circumstances, there is an especially acute need for protecting the casting solution 12 against localized currents and the foraminous shield 28 of the example embodiments is very effective in performing this function.

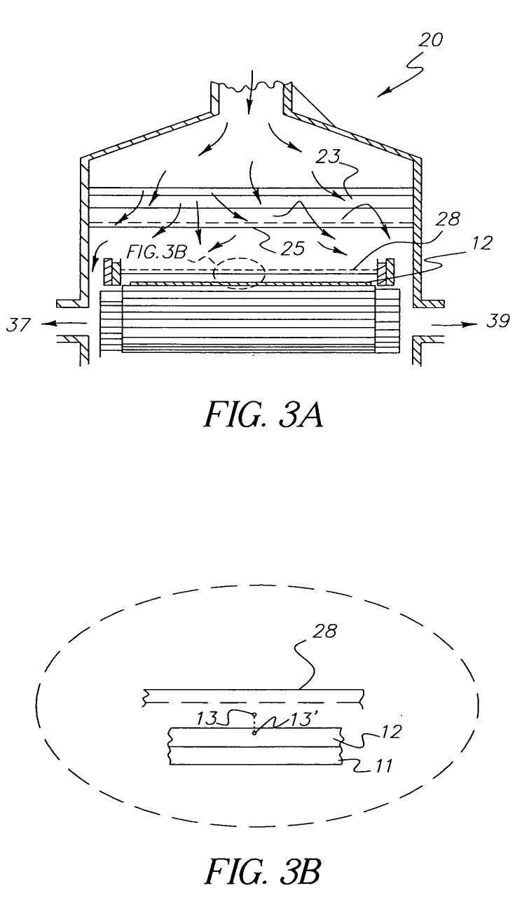

FIG. 3a shows the drying chamber 20 of FIG. 2 in cross-section transverse to the cross-section of FIG. 2. Fresh drying air passes (shown as arrows) through distributing plate 23 and over the edges of baffles 25 to provide a steady, uniform, low velocity flow which promotes uniform drying. Spent drying air flows transversely of the path of casting solution 12 and over the edges of casting solution 12 to exit from ducts 38 and 39. Air provided by heating internal to the band loop shown in FIGS. 1 and 2, also exits from the same side casing ducts.

Illustratively, the gaseous drying medium (drying air) passes from the plenum through the foraminous shield 28 to contact the casting solution 12. At the same time, spent gaseous drying medium, containing vapor generated by evaporation of the liquid medium (solvent) in the casting solution, passes through the foraminous shield 28 in the opposite direction and flows away from the path of the casting solution to exit from the drier. As alluded to previously, the foraminous shield 28 provides a physical barrier that reduces, if not eliminates non-uniform airflow in the region between the lower surface of the shield 28 and the upper surface of the casting solution 12. As such, turbulent air flow and direct contact of the gaseous drying medium with the top surface of the casting solution 12 during the drying process are substantially avoided. As is known, turbulent airflow can dry certain regions of the top surface of the casting layer at greater rates than other regions and often form a skin layer on the top surface that further prevents the evaporation of the solvent. In addition, significant contact of the gaseous drying medium with the surface of the casting solution 12 can result in uneven drying of the casting solution 12. Ultimately, these factors can result in non-uniform thickness of the casting solution 12. However, by virtue of the foraminous shield 28, the flow of the spent gaseous drying medium is substantially out of contact with the surface of the casting solution 12, and turbulent airflow such as eddy currents are substantially avoided.

In addition, the foraminous shield 28 maintains a relatively low concentration of gaseous drying medium and a relatively high concentration of solvent vapor between the lower surface of the shield 28 and the top surface of the casting solution 12; and a relatively high concentration of gaseous drying medium and a relatively low concentration of solvent vapor above the top surface of the foraminious shield 28. Ultimately, the highly volatile solvent is removed safely, and defects such as streaking and S.R.T.V. formation in the casting solution 12 are greatly reduced.

Performance of the foraminous shield 28 is dependent on the distance between the foraminous shield 28 and adjacent plenum wall 40 and the distance between the foraminous shield 28 and the surface of the casting solution 12. The optimum distances are determined by many factors, including the pressure at which the drying medium is delivered, the size of the perforations, the percentage of open area, and so forth. Under typical conditions, good results are obtained with a spacing between the foraminous shield 28 and the adjacent plenum wall 40 in the range of approximately 5.0 cm to approximately 100 cm; and a spacing between the top surface of the casting solution 12 and the opposing (bottom) surface of the foraminous shield 28 in the range of approximately 1.0 cm to approximately 5.0 cm.

As will become clearer as the present description continues, the shield 28 may consist of a single layer of foraminous material, or may be multi-layered structure. In certain example embodiments of multi-layered shields, the layers of foraminous material are substantially in contact with each other, while in others controlled gaps are maintained between the layers. Finally, in example embodiments having more than one layer of foraminous material, the referenced distance range between the casting solution 12 and the foraminous shield 28 is measured from the top of the casting solution 12 to the bottom surface of the bottom-most layer of foraminous material 28.

In addition to functioning to prevent turbulent airflow and direct contact with of the gaseous drying medium with the casting solution, the foraminous shield 28 fosters a relatively slow drying process by providing a relatively high concentration of solvent vapor at the surface of the casting solution 12. To this end, during the drying process, the shield 28 substantially suppresses dispersion of the solution vapor generated by evaporation of the solvent (liquid medium) from the casting solution 12. This results in an equilibrating of the rate of diffusion at the surface of the casting solution 12 with the rate of diffusion through the bulk of the casting solution 12. As such, the solvent at the surface of the casting solution 12 is ‘refreshed’ by the solvent in the casting solution. This is illustrated in FIG. 3b, which is an enlarged view of a section of FIG. 3a. FIG. 3b shows the foraminous shield 28 disposed over the casting solution 12, which is disposed over the band 11. Due to the equilibrating of the rate of diffusion of liquid medium from the casting solution during drying, at a location 13 above the casting solution, the solvent concentration is at a particular level at a particular time. Moreover, at a location 13′ beneath the location 13, the solvent concentration in the surface of the casting solution 12 is nearly near equilibrium with the solvent concentration at location 13. Illustratively, the location 13′ is slightly beneath the surface of the casting solution.

Beneficially, the providing of a solvent rich atmosphere slightly less than the vapor-liquid equilibrium concentration at the surface of the casting solution 12 acts to retard drying process and to prevent the uneven drying of the casting solution 12. Accordingly, the shield 28 fosters conditions conducive to substantially uniform removal of the solvent from the casting solution, and thus uniform drying. The substantially uniform drying results in substantially uniform thickness of the casting solution 12.

As can be appreciated from the previous description, it is beneficial to retard the drying process. In accordance with example embodiments, this slowing of the drying process is carried out by maintaining the solvent concentration above the surface of the casting solution 12 and beneath the foraminous shield 28 slightly below the solvent vapor-liquid equilibrium concentration at a surface of the casting solution. To this end, when dealing with a liquid solution (e.g., casting solution), and a vapor phase adjacent to the liquid solution (e.g., the solvent vapor), there exists a fixed set of equilibrium concentrations of the components in the liquid and air phase. These concentrations are defined by the materials, concentrations, temperatures and pressure of the liquid/vapor system.

As can be appreciated, if the solvent vapor and the liquid at the surface of the casting solution were at equilibrium, no net diffusion takes place between phases, as there is no driving force. Thus, if the foraminous shield 28 were run at conditions where equilibrium was maintained, no drying would take place, and the beneficial effects would not be observed. Thus, the drying operation using the foraminous shield 28 of the example embodiments requires a shift of the vapor/liquid phase conditions away from the equilibrium condition, and drying can take place under conditions where the rate of mass transfer through the liquid is balanced with the rate of mass transfer away from the surface into the gas phase, and the beneficial effect is observed. Thus, the example embodiments provide setting and maintaining the solvent concentration above the surface of the casting solution 12 and beneath the foraminous shield 28 slightly less than the solvent vapor-liquid equilibrium concentration at a surface of the casting solution. While techniques to set and maintain such conditions will be readily apparent to one of ordinary skill in the art having had the benefits of the present disclosure, applicants have discovered that the setting and maintaining of conditions of the solvent concentration above the surface of the casting solution 12 and beneath the foraminous shield 28 to be slightly less than the solvent vapor-liquid equilibrium concentration at a surface of the casting solution is determined readily via experiments on each instance of the apparatus, using the quality (i.e., thickness uniformity) of the dried web as the response variable.

A further understanding of the benefits of the effect of the foraminous shield 28 of the example embodiments can be obtained by considering two adjacent elements/portions of the casting solution 12 which are drying to form a web. If the first element should dry more rapidly than the second element, it will lose volume and contract. Due to the elastic nature of polymer solutions, this shrinkage will move material from the less dried region to relieve the stresses caused by this shrinkage. This results in a permanent change in the thickness of the dried layer. By reducing the drying rate via the high concentrations of solvent vapor under the foraminous shield, the variability in the drying rate is also reduced, which consequently reduces forces that would cause fluid displacement in the drying casting solution. This differential in drying rate can also occur if a portion of the drying layer initially dries very rapidly. This will form a skin that i's more impervious to solvent evaporation than an adjacent element that has not formed a skin. This causes a difference in drying rate which results in movement of the polymer solution and permanent thickness variations.

The foraminous shield 28 can extend over the entire length of the casting solution drying on the casting surface (band 11). However, this is not ordinarily necessary. The shield 28 functions in the initial stage of the drying process and, accordingly, is also effective when used only in the initial portion of the drier. Good results are typically achieved with the foraminous shield extending from the start of the first drying zone over a distance equal to approximately 75 percent of the total length of the first drying zone. Notably, in certain example embodiment, the foraminous shield may extend approximately 20 percent to approximately 50 percent of the length of the first drying zone. The shield 28 is important only in the first drying zone. If the foraminous shield 28 extends beyond the first drying zone, it reduces the drying rate without enhancing the uniformity. Once the cast layer is dried to a sufficient amount, the material essentially ‘gels’ and will not flow, even though there is still a substantial solvent content.

The foraminous shield 28 illustratively has a width which is substantially commensurate with the width of the coated surface of the sheet material (casting solution 12), and may be somewhat greater than such width, in order to provide protection for the entire coated surface. Optimum results are achieved when a foraminous shield is also utilized in the early coating zone adjacent the inlet to the drier to protect the flow of coating composition from disturbance by ambient air currents during the coating operation. To achieve the significant benefit, the foraminous shield 28 substantially encloses the flow of coating composition during the coating operation, extends over the coated casting solution in the region between the coating hopper and the first drying zone, and extends over the coated casting solution as it passes through the drier, and is positioned within the drier in close proximity to the path of the casting solution over a suitable initial portion of the total length of the path.

Since the foraminous shield 28 of the example embodiments tends to suppress the evaporation rate by confining the evaporated vapor, and thereby slow the drying process, the shield 28 usefully does not extend into the drier further than is needed to achieve the objective of reducing drying rate induced thickness variation. In this way, the objective of achieving relatively rapid drying in a drier of reasonable length is achieved simultaneously with the objective of drying substantially evenly to provide a layer of substantially even thickness. Notably, the suppressed reduction in the drying rate is readily addressed by extending the length of the drier or by utilizing drying air which impinges on the backside of the continuous casting band 11. The warm air that impinges on the backside of the band 11 is effective in introducing heat into the casting solution to thereby promote evaporation of the liquid medium in the coated layer.

As alluded to above, the example embodiment reduce if not eliminate the formation of a surface skin on the casting layer. Beneficially, this enhances thickness uniformity. Another benefit controlling the surface skin on the casting layer is the ability to apply higher heat (e.g., warmer air) to the bottom of the band 11 without the formation of bubbles internal to the casting solution. In known drying techniques, increased temperatures in the casting solution can increase the local diffusion rate, and if an impediment to diffusion, such as a skin layer, is present, bubbles will form. This is substantially avoided via the example embodiments.

A significant reduction in S.R.T.V. can be achieved by the method and apparatus of the example embodiments in the coating and drying of various film-forming material, or mixture of film-forming materials. Illustratively, the film-forming materials are incorporated in a casting composition, which comprises an evaporable liquid medium. The methods and apparati of the example embodiments are particularly useful in the coating and drying of solutions of polymeric resins in organic solvents because such solvents are often relatively volatile in nature and, in consequence, coatings formed therefrom are prone to surface defects from the stresses caused by collapse of the drying polymer skin as the solvent is evaporated from the depth of this sheet. Notably, the film-forming materials include: acetals, acrylics, acetates, cellulosics, amides, ethers, carbonates, styrenes, and the like. The polymers can be homopolymers or they can be copolymers formed from two or more monomers. Illustratively, the polymers include polycarbonates, polyamides, polystyrenes, polymethyl methacrylate, polyolefin, polysulfone, cellulose diacetate, cellulose triacetate, cellulose acetate propionate, cellulose acetate butyrate, bisphenol-A-polycarbonate, bisphenol-A-trimethylcyclohexane-polycarbonate, bisphenol-A-phthalate-polycarbonate, or norbornene resins, to name only a few. In addition, the casting solution may comprise a cellulosic coating composition.

Liquid vehicles for use in the coating composition can be chosen from a wide range of suitable materials. For example, the coating composition can be an aqueous composition or an organic solution comprising an: organic solvent. Typical organic solvents include ketones, such as acetone or methyl ethyl ketone, hydrocarbons such as benzene or toluene, alcohols such as methanol or isopropanol, halogenated alkanes such as methylene chloride, ethylene dichloride or propylene dichloride, esters such as ethyl acetate or butyl acetate, and the like. Naturally, combinations of two ore more organic solvents can be utilized as the liquid vehicle or the liquid vehicle can be a mixed aqueous-organic system.

The weight percentage of polymer solids in the dope casting composition will typically be in the range of approximately 15 percent to approximately 40 percent by weight. Viscosity for the coating composition will depend on the type of coating apparatus employed and can be as high as approximately 8,000 poise, or more, but will more typically be in the range from approximately 1,000 poise to approximately 6,000 poise. In addition to the film-forming material and the liquid vehicle, the coating composition can contain various optional ingredients such as pigments, viscosity modifiers, UV light blockers, plasticizers, and so forth.

Coating compositions that present particular difficulty in known methods and apparati because of their pronounced tendency to rapidly dry and resulting skin and sheet defects are those in which the liquid vehicle is relatively volatile. It is with these coating compositions that the methods and apparati of the example embodiments are also useful. In particular, such compositions are those in which the liquid vehicle is an organic solvent having a boiling point at atmospheric pressure in the range of from approximately 35° C. to approximately 65° C.

The layer, which is coated and dried by the method of this invention, can be composed of a variety of materials provided the material can be coated with a liquid coating composition. The object is normally a sheet material which is coated as a continuous casting solution in a continuous casting process. Typical examples of useful sheet materials are polymeric films such as films of cellulose esters and polycarbonate.

In the interest of increasing the operating rate of the machine, it can be beneficial to include a high percentage of solids in the coating composition to thereby permit coating at a low wet coverage and with a high viscosity. This increases the sensitivity of the casting solution to variations in drying rate, and can promote thickness variations driven by drying.

As can be appreciated, the particular conditions utilized in the process of the example embodiments will vary greatly, depending on the particular product being manufactured and the selection of optimum conditions for a given product is, in light of the disclosure herein, within the ordinary skill of the art. Factors affecting the process include the design of the foraminous shield, the thickness and composition of the coated layer or plurality of superposed layers, the speed with which the drying polymer material is conveyed through the drier, the design of the drier, and the volumetric flow rate and temperature which the air, or other gaseous drying medium, is supplied to the drier. In optimization of the process, a key objective is to provide controlled rates of heat and mass transfer at all points on the coated surface. Numerous factors affect such rate of heat transfer, including the temperature and humidity of the gaseous medium, the plenum pressure, and the spacing between the plenum and the coated surface.

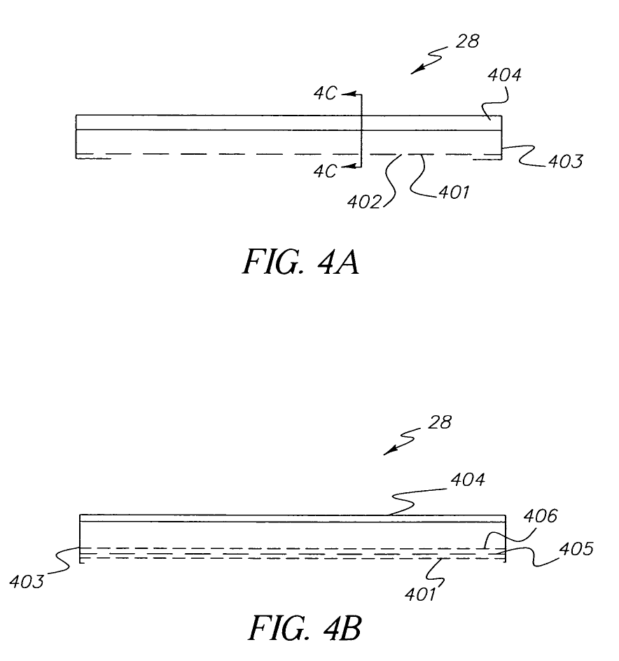

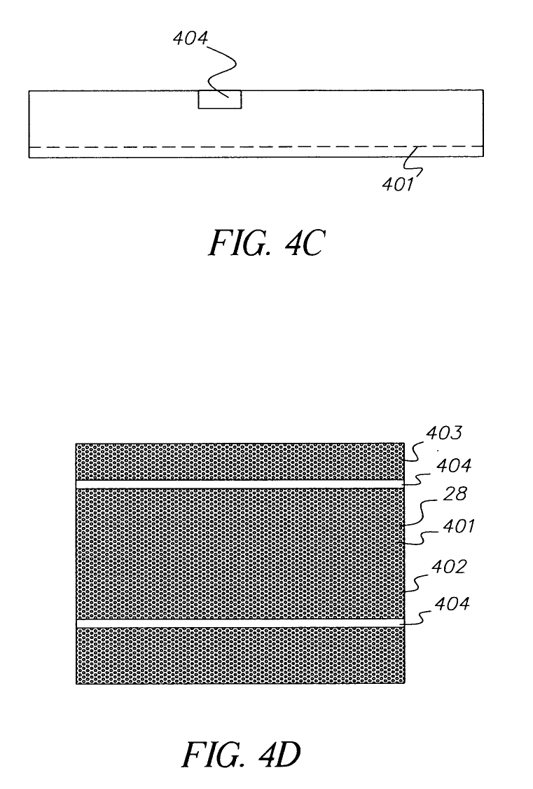

FIGS. 4a-4d show the foraminous shield 28 in accordance with illustrative embodiments. Turning initially to FIG. 4a, the shield 28 comprises a single layer of foraminous material 401. The foraminous material 401 comprises a plurality of pores or foramina 402. The foraminous material 401 also includes supports 403 and at least one reinforcing bar 404 disposed over one side thereof. FIG. 4c shows the foraminous material 401 of FIG. 4a in cross-section taken along the line 4c-4c. As can be seen along the lengthwise cross-section of FIG. 4c, the reinforcing bar 404 is disposed over only a portion of the area of the foraminous material 401 and of the shield 28. FIG. 4d shows the shield 28 in top view. From FIG. 4d, the plethora of pores 402 comprising the foraminous material 401 are in plain view.

FIG. 4b shows a foraminous shield 28 that includes a plurality of layers of foraminous material. To wit, foraminous material layer 401, a foraminous material layer 405 and a foraminous material layer 406 comprise the multi-layer shield of the example embodiment. Notably, the number of layers of foraminous material shown in this embodiment is merely illustrative. It is contemplated that more or fewer layers may be employed. These layers may be of similar open area or of differing open areas. Depending on the machine and plenum configuration, a single layer may be sufficient. If the airflow in initially too nonuniform, the addition of more layers creates additional impediment to the air streams and forces equilibration of the airflow through the subsequent screen. The layers are normally substantially in contact with each other, although spacing of the screens can also provide a suitable effect.

The shields 28 of the various illustrative embodiments may be constructed of a variety of materials. Notably, the layers of foraminous material 401, 405 and 406 may comprise metal screening, perforated metal plates, plastic sheeting have a multiplicity of fine holes formed therein, perforated paper, netting such as nylon or other fabric netting stretched taut within a frame, and the like.

Factors affecting the performance of the foramina's shield structure of this invention include:

(1) The size of the perforations (pores 402),

(2) The spacing of the perforations,

(3) the shape of the perforations (e.g. round, square, elliptical in cross-section),

(4) whether the structure is a single-layer or multi-layer structure

(5) the distance between the walls where it is a multi-wall structure

(6) whether or not the perforations are aligned when it is a multi-layer structure,

(7) the thickness of the foraminous material,

(8) the edge design of the shield structure (i.e., whether it is formed parallel or perpendicular to the casting surface

(9) the distance between the foraminous shield and the adjacent wall of the plenum, and

(10) the distance between the foraminous shield and the coated surface on the casting support.

All of the above factors are matters of design choice and can be varied widely to achieve optimum results with a particular drying system.

Both the size and spacing of the perforations are features to be considered in determining the efficiency with which the foraminous shield structures of this invention operate. Very good results are typically obtained with perforations or pores having a size in the range of approximately 0.1 mm to approximately 30 mm, and illustratively in the range of approximately 0.1 mm to approximately 1.25 mm. Illustratively, the pitch or spacing is chosen so the percentage of open (perforated) area of the screen (e.g., 401) is in the range of approximately 10 percent to approximately 65 percent, and illustratively in the range of from approximately 20 percent to approximately 50 percent.

Notably, as used herein in conjunction with the description of the foraminous material, size ranges specified for the perforations 402 refer to the diameter where the pores have a circular cross-section and to the maximum dimension where the cross-section of the pores are other than circular in shape. It is also noted that an alternative way of referring to percentage open area is by reference to the “solidity” of the shield, by which is meant the fraction of the total flow area blocked by the shield. For example, a solidity of 0.40 means 40% ‘blocked’ and 60% ‘open’.

In contrast with the size and spacing of the perforations, the shape of the perforations is not a particularly important parameter. As such the cross-section of the perforations can be of virtually any desired shape.

The thickness of the foraminous material from which the shield is formed is also a factor to be considered in determining operating effectiveness. In general, it is desirable that the foraminous material (e.g., layers 401, 405, 406) be as thin as is practical. To this end, thin layers are useful because all factors being equal, a thin material is more effective than a thick one in reducing turbulence. Good results are typically obtained using foraminous materials with a thickness of less than approximately 2.0 mm. Thus, whether the shield is constructed from a framework of wire screens, in which the thickness is dependent on the diameter of the wire from which the screen is formed, or from a perforated plate material, it is beneficial for its thickness to be less the specified value of approximately 2 mm.

The edge design of the foraminous shield can also affect its performance. Thus, for example, it is preferred that the shield extend somewhat beyond the edges of the coated layer to avoid disturbance of the coated layer resulting from “edge-effect” turbulence. As an alternative to extending the shield beyond the edges of the coated layer, it can be angled sharply downward along its edges.

In the apparati of the example embodiments, the foraminous shield is positioned in close proximity to the surface of the coated layer, but it is often advantageous for it to be spaced relatively far from the plenum (e.g., as shown in FIG. 1). For example, in those instances in which the vapors generated in the drying process are explosive, it is desirable that the distance between the foraminous shield and the adjacent plenum wall be large relative to the distance between the foraminous shield and the surface of the coated layer; so as to maintain an average vapor concentration which is at a safe and low level. Under such circumstances, it is useful for these distances be in a ratio in the range of from approximately 2 to 1, to approximately 20 to 1, and in the range of from approximately 4 to 1 to approximately 20to 1.

A particular benefit of the use of a foraminous shield in accordance with example embodiments is that the air or other gaseous drying medium can be supplied from the plenum at a greater pressure, without detrimentally affecting the coating, than would be feasible without the use of the foraminous shield. The delivery of a greater volumetric flow of air that results from such increased pressure means that the percentage of vapor in the spent air is lower. This is highly advantageous in dealing with potentially hazardous vapors, such as those generated by organic solvents, since it provides a greater margin of safety in keeping well below the explosive limits.

While reference has been frequently made herein to a “drying zone” it is to be understood that such zone can, and often will, be comprised of a series of sub-zones, each of which provides different drying conditions. For example, the drying zone may consist of a series of sub-zones utilizing progressively higher temperatures. Such practices are well established, and their purposes clearly understood in the coating and drying arts.

The method and apparati of the example embodiment are useful in a wide variety of processes. For example, they are useful in the drying of either single-layer or multiple-layer coatings by various processes including those in which a chill-setting zone is used in association with a drying zone; and in either or both of the drying steps of a sequential coating process in which a single or multiple-layer coating is applied over a previously applied and dried single or multiple-layer coating.

### EXAMPLES

Certain examples are provided to further illustrate the methods and apparatus of the example embodiments. It is emphasize that these examples are intended to illustrate and not limit the example embodiments.

A film sample dried accordance with example embodiments and having a size of approximately 10.0 m in length by full width was sampled from the dried film. The sample was laid on a flat black felt table, which was sloped at approximately 30 degrees toward the observer, lighted by four fluorescent light tubes arranged in parallel above the black felt surface, at a height of 2 m. The state of the film surface was visually observed and classified in to the following ratings according to the state of the reflected image of the fluorescent light tubes, on the sample. This visual method allows the viewer to carefully observe the nature of the film surface. A mirror like reflection is only possible from a very smooth film surface. The surface judgment is characterized by the appearance of the reflected (from the sheet) lines of the overhead fluorescent tubes.

The following were observed:
1: The reflected images of the fluorescent lights were straight and no short-range deviations were observed.
2: The reflected images of the fluorescent lights were slightly curved and tube edge distortions were observed a little.
3: The reflected images of the fluorescent lights were partially curved and tube edge distortions were observed to some degree.
4: The reflected images of the fluorescent lights were irregular and many distortions were observed.

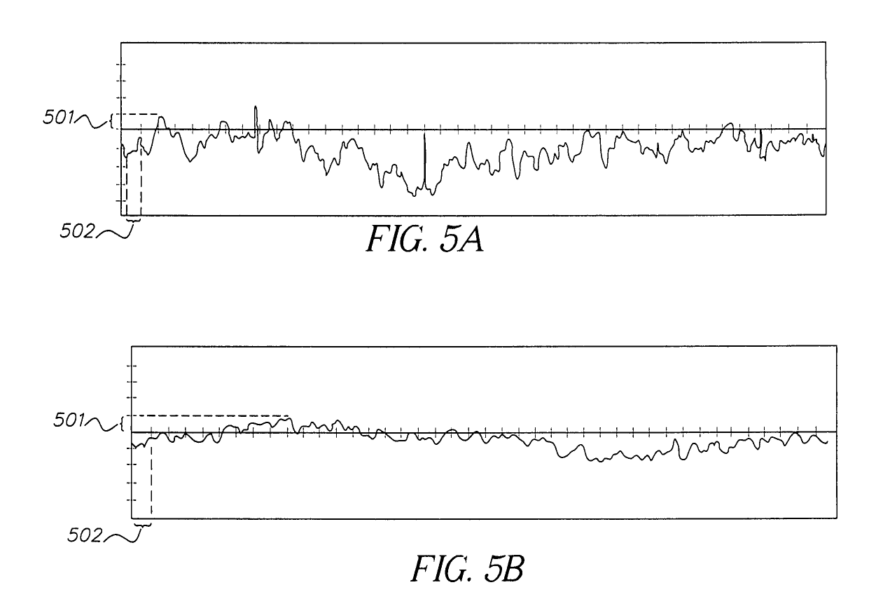

Another method to characterize the cast sheet surface quality is contact profilometery. Two example traces are shown in FIGS. 5a and 5b in which the vertical axis has a scale of 1.0 μm per line (shown as 501) and the horizontal axis has a scale of 1.0 cm per line (shown as 502). The trace of FIG. 5a is an 80 μm aim thickness sheet sample, prepared without any foraminous shield; the early drying air was allowed to impinge on the sheet. The trace of FIG. 5b is an 80 μm aim thickness sheet with good surface quality created dried in accordance with a method and apparatus of an example embodiment. The thickness trace is created by a Schaevitz contact gauge. The sheet sample is slit to 35 mm and lubricated with a light oil. An indexing motor moves the sheet at a constant rate under the stylus of the thickness gauge. The data is correlated and a thickness map of the sheet sample is generated. These charts are measured transverse to machine direction. The defect created by poor early drying can be described as short-range thickness variation (SRTV). Notably, an undesirable surface defect can be characterized by a thickness variation of approximately 1.0 μm to approximately 3.0 μm over a pitch of approximately 3.0 cm to approximately 5.0 cm. The distinct improvement in surface quality can be seen between the two samples.

### Example 1

A casting solution is cast on a machine, with an endless polished band, which is turned on two tensioned drums 9, with a diameter of approximately 36 cm, as shown in FIG. 1. The polymer solution is supplied to the casting hopper, which is top dead center on the casting drum. The exact location of the casting hopper is not critical, but it should be positioned to allow maximum curing surface for the drying sheet, prior to stripping. The polymer solution is applied with dissolved solids consisting of 20 wt. % cellulose tri-acetate and 2 wt. % tri-phenyl phosphate in a solvent system consisting of 90 wt. % methylene chloride and 10 wt. % methanol. Other solvent systems or plasticizers can be used, but methylene chloride and methanol are the most practical and industrially used solvent system for tri-acetylated cellulose. The casting surface of the polished band is 4.9 meters long and the effective length is 4.7 meters, with consideration for the unused gap between the casting hopper and the stripping roller. The band is rotated to create a casting speed of 2.16 meters/minute. The drying sheet has a residence time on the band of 130 seconds, from casting to stripping.

Shortly after casting, the polymer casting solution undergoes a rapid flash of solvents until a polymer skin is formed over the softer bulk of the sheet. Once the skin is well established the drying rate of the polymer solution is rapidly diminished. The undesirable short-range thickness variation is created during the uncontrolled initial flash of solvents. Once the sheet has skinned over, the defect is locked into the sheet and further airflow will not alter the surface for better or worse. To determine the sensitive time frame for the cast sheet, with regard to surface uniformity, a second slot hopper was positioned over the drying sheet. It could be moved over the top surface of the casting band. Air was blown from the slot with a velocity of 30 cm/second and the hopper was 5 cm above the drying sheet. This could be characterized as a very gentle impingement air stream. The air knife was wide enough to treat the whole sheet at once. The drying air in the top strand of the band section was severely restricted to minimize any airflow and the hopper was positioned down the band to test the sensitivity of the sheet to air impingement and the formation of surface roughness. This method was used to determine the time, or length extent at 2.16 meters/min speed, needed for a useful foraminous shield.

| Air Knife Position | time | |
|---|---|---|
| in cm from | separation | sheet surface |
| casting point | in seconds | quality |
| None | | 2 |
| 42 | 12 | 4 |
| 46 | 13 | 4 |
| 53 | 15 | 4 |
| 60 | 17 | 3 |
| 69 | 19 | 3 |
| 75 | 21 | 3 |
| 84 | 23 | 3 |
| 91 | 25 | 3 |
| 107 | 30 | 3 |
| 122 | 34 | 2 |
| 137 | 38 | 2 |
| 152 | 42 | 2 |

The data presented here indicate that the formation of surface roughness is occurring in the first 30 to 35 seconds after casting. Impinging air on the sheet after this point in sheet drying does not influence sheet flatness. This experiment is also a function of drying conditions. With drying air severely restricted from the top strand of the band, the drying rate was reduced from a desirable position. With a perforated shield in place the drying rate would be increased and the opportunity to damage the surface quality of the sheet would be lessened. This calculation is also a function of the casting band speed. Cellulose tri-acetate sheet can be formed at higher speeds and the required foraminous shield would need to be longer to provide good surface quality with faster sheet movement.

### Example 2

In this example, the top strand of the band is covered with a perforated sheet metal plate. The plate is perforated with closely spaced 13 mm holes throughout the whole effective surface. Total casting band length is 4.9 meters, with the turning drums taking up 1.13 meters in two half circles, the top and bottom strand are 1.88 meters in straight section. Shielding extends immediately from the backside of the extrusion hopper, 1.88 meters to the point where the band turns around the tension drum. The metal shield has folded lips that stiffen the metal sections. These stiffening bends are made away from the casting band and the sections are bolted together to form a continuous surface that is flat on the casting band side. It is important to keep the operating side of the shield flat to prevent airflow turbulence between the shield and the moving wet polymer solution. On the perforated plate, fine metal screens are placed opposite the band side. These screens are removable and can be stacked in multiple layers. The screen mesh hole openings and multiple screen layers can be used to adjust the barrier to air intrusion, as required to control sheet surface quality. For this testing, all the areas of the shield are covered with one layer of 0.105 millimeter opening fine screen (Tyler designation #150 mesh).

Sample ports were provided through the perforated casing to sample the environment under the casing. The casting machine was operated at 2.16 meters per minute, creating a final dry sheet thickness of 80 micron cellulose tri-acetate film. Gas samples were extracted from the gap under the air flow shield and sent to a Perkin-Elmer ICP-mass spectrometer. Analysis of the solvent vapors from the controlled air gap was conducted directly. Composition of the dope solution was 20 wt. % cellulose tri-acetate, 2 wt. % tri-phenyl phosphate with a solvent system of 90 wt % methylene chloride and 10 wt. % methanol.

Initially, the gap between the airflow casing and the polished casting band was set at 2 centimeters. Gas samples were extracted at 40 cm, 80 cm, and 120 cm, and 160 cm away from the casting hopper underneath the 188 cm long air shield.

Solvent concentrations at each point:

| | | | |
|---|---|---|---|
| 40 cm. methylene | 24.3 | volume % | methanol2.7 volume % |
| chloride | | | |
| 80 cm. methylene | 7.3 | volume % | methanol0.9 volume % |
| chloride | | | |
| 120 cm. methylene | 2.0 | volume % | methanol0.3 volume % |
| chloride | | | |
| 160 cm. methylene | 0.6 | Volume % | methanol0.1 volume % |
| chloride | | | |

The surface quality of this sheet was judged rating 1 which is excellent.

The test was reproduced with the same foraminous baffle raised to 5 cm above the endless casting band. Gas sampling was conducted in an identical manner.

| | | | |
|---|---|---|---|
| 40 cm. methylene | 22.3 | volume % | methanol2.5 volume % |
| chloride | | | |
| 80 cm. methylene | 2.7 | volume % | methanol0.5 volume % |
| chloride | | | |
| 120 cm. methylene | 1.0 | volume % | methanol0.3 volume % |
| chloride | | | |
| 160 cm. methylene | 0.6 | volume % | methanol0.1 volume % |
| chloride | | | |

The surface quality of this support was judged to be excellent with a rating of 1.

A third casting experiment was conducted with the cover screen shortened to 100 cm. and spaced 2 cm. over the casting band.

| | | |
|---|---|---|
| 40 cm. methylene | 7.3 volume % | methanol1.3 volume % |
| chloride | | |
| 80 cm. methylene | 1.6 volume % | methanol0.3 volume % |
| chloride | | |

This sheet was judged to be poor for surface quality with a rating of 3.

The fourth variation raised the 100 cm casing to 5 cm.

| | | |
|---|---|---|
| 40 cm. methylene | 5.2 volume % | methanol.8 volume % |
| chloride | | |
| 80 cm. methylene | 1.2 volume % | methanol0.3 volume % |
| chloride | | |

This sample was judged to be poor with a surface rating of 3

A final sample was produced with no baffling present on the top band section. The sample was rated to be of very poor surface quality with a rating of 4.

### Example 3

In the present examples, the airflow above and around the drying shield is altered. The curing shield on a larger machine will have differential pressure down the length of the drying casing. This can cause generalized airflow under the casing. If the speed of the drying air is poorly matched to the casting speed of the drying polymer solution, a turbulent condition can be created which results in short range surface roughness on the scale of approximately 1.0 mm to approximately 2.0 mm microns with a pitch of approximately 3.0 mm to approximately 5.0 mm. In this example, the top strand of the band is covered with a perforated sheet metal plate. The plate is perforated with closely spaced 13 mm holes throughout the whole effective surface. Total casting band length is 4.9 meters, with the turning drums taking up 1.13 meters in two half circles, the top and bottom strand are 1.88 meters in straight section. Shielding extends immediately from the backside of the extrusion hopper, 1.88 meters to the point where the band turns around the tension drum. The metal shield has folded lips that stiffen the metal sections. These stiffening bends are made away from the casting band and the sections are bolted together to form a continuous surface that is flat on the casting band side. It is important to keep the operating side of the shield flat to prevent airflow turbulence between the shield and the moving wet polymer solution. On the perforated plate, fine metal screens are placed opposite the band side. These screens are removable and can be stacked in multiple layers. The screen mesh hole openings and multiple screen layers can be used to adjust the barrier to air intrusion, as required to control sheet surface quality. For this testing, all the areas of the shield are covered with one layer of 0.105 millimeter opening fine screen (Tyler designation #150 mesh).

Airflow is controlled by two gates, which determine the pressure differential under the length of the casing. The overall airflow can be controlled by the speed of the fan supplying pressure to the air system. Reported fan speed is the frequency of an AC drive package where 60 Hz is 100 percent speed. The correct settings on the two supply gates will regulate the pressure differential and flow under the casing. The casting process is run at 2.75 meters/min and the speed matching is done by visual observation of the solvent vapors. The S.R.T.V. is rated by the visual technique. Solvent concentration was monitored with an ICP-mass spectrometer.

| | | Under 1^{st} | |
|---|---|---|---|
| Fan speed | solvent flow | casing vol. % | SRTV |
| (Hz.) | direction | Solvent Conc. | rating |
| 35 | speed matched | 20.73 | 1 |
| 42 | speed matched | 16.47 | 1 |
| 49 | speed matched | 14.60 | 2 |
| 35 | reverse flow | 17.9 | 4 |
| | over band | | |
| 42 | reverse flow | 15.8 | 4 |
| | over band | | |
| 49 | reverse flow | 11.5 | 4 |
| | over band | | |
| 35 | faster than band | 9.4 | 2 |
| 42 | faster than band | 5.5 | 3 |
| 49 | faster than band | 4.5 | 3 |

From the foregoing, it is appreciated that the methods and apparati of the example embodiment are useful in a wide variety of processes. For example, they are useful in the drying of either single-layer or multiple-layer coatings by various processes including those in which a chill-setting zone is used in association with a drying zone; and in either or both of the drying steps of a sequential coating process in which a single or multiple-layer coating is applied over a previously applied and dried single or multiple-layer coating. To this point, the casting surface has been a continuous band. However, this is merely illustrative. To this end, the casting surface may be a discontinuous substrate as described, in US Patent Publication 20030215582, the invention of which is assigned to the present assignee; and the disclosure of which is specifically incorporated herein by reference. In addition, the casting surface may be a casting wheel, such as presently described.

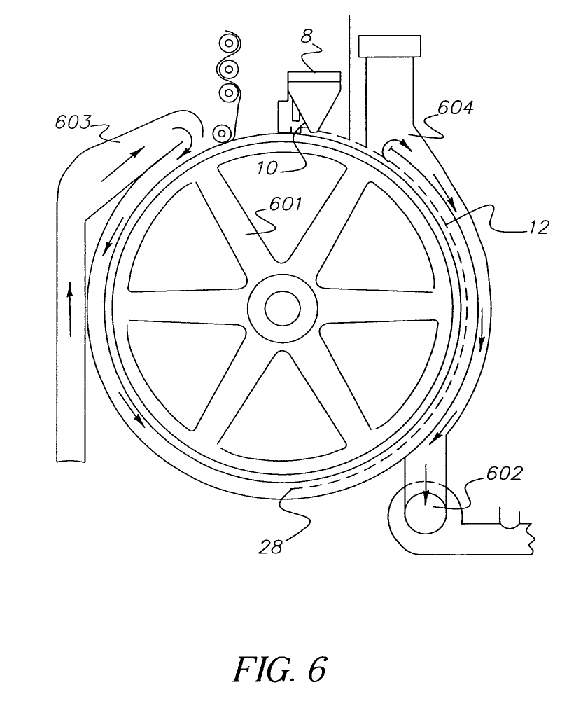

FIG. 6 is a cross-sectional view of a casting wheel useful in drying a casting solution 12 in accordance with an example embodiment. Notably, many of the details described in connection with the example embodiments of FIGS. 1-5 are common to the presently described example embodiment. In order to avoid obscuring the description of the present example embodiment, these details are not repeated.

Sheet raw material is fed to the system as a pumped solvent and polymer solution 8, to form a continuous casting solution from the polymer extrusion hopper 10. The carefully controlled sheet extrusion lay on the highly polished band 11. Illustratively, the band 11 is held in a substantially circular shape and is disposed over a casting wheel 601, which rotates in a clockwise fashion. The high polish on the band is useful in providing good surface quality to the formed polymer sheet. Notably, the band 11 may be omitted and the casting surface may be an outer surface of the wheel 601.

The wheel 601 is heated to foster the drying process in much the same way that the drums 9 of the previously described embodiments are heated. Moreover, the movement of the wheel 601 and the vapor-phase solvent between the band 11 and the foraminous shield are substantially the same. Thus the casting solution 12 on the band travels at substantially the same rate as the solvent vapor above the solution.

Vents 602 and 603 provide airflow in much the same manner as the plenums and chambers previously described. Finally, a take-up 604 gathers the web for further processing.

In accordance with illustrative embodiments, drying of casting solutions having substantially uniform thickness and a reduced incidence of surface defects compared to films formed by other techniques is achieved. It is emphasized that the various methods, materials, components and parameters are included by way of example only and not in any limiting sense. Therefore, the embodiments described are illustrative and are useful in providing beneficial light distributions. In view of this disclosure, those skilled in the art can implement the various example devices and methods to effect light distributions, while remaining within the scope of the appended claims.

### Parts List

8 sheet raw material
9 turning drum
10 polymer extrusion hopper
11 highly polished band
12 continuous casting solution
13 location above the casting solution
13′ location beneath location 13
15 stripping roller
20 drying chamber
22 drying chamber
23 distributing plate
24 drying chamber
25 baffle
27 plenum
28 foraminous shield
29 plenum
30 product side chamber
31 product side chamber
32 product side chamber
33 product side chamber
34 product side chamber
35 product side chamber
36 guide roll
38 take-up roll
40 plenum wall
41 chamber
42 chamber
43 chamber
401 layer of foraminous material
402 pores (foramina)
403 support
   List—continued
404 reinforcing bar
405 foraminous material layer
406 foraminous material layer
601 casting wheel
602 vent
603 vent
604 take-up

1. A method of drying a casting solution, the method comprising: advancing the casting solution in an opposed closely spaced relationship with a foraminous shield, which is substantially permeable to a gaseous drying medium, wherein a solvent vapor concentration above a surface of the casting solution is slightly less than a solvent vapor-liquid equilibrium concentration at a surface of the casting solution.

2. A method as recited in claim 1, wherein the solvent vapor above the surface of the casting solution advances at a rate and a direction that is substantially the same as a direction and a rate of the advancing of the casting solution.

3. A method as recited in claim 1, wherein the foraminous shield comprises a perforated metal plate.

4. A method as recited in claim 1, wherein the foraminous shield comprises a framework containing metal wire screens.

5. A method as recited in claim 1, wherein further comprising an organic solvent.

6. A method as recited in claim 1, wherein the organic solvent has a boiling point at atmospheric pressure in the range of approximately 35° C. to approximately 65° C.

7. A method as recited in claim 1, wherein the gaseous drying medium is air.

8. A method as recited in claim 1, wherein the casting solution is a cellulosic coating composition.

9. A method as recited in claim 1, wherein the foraminous shield comprises a single screen.

10. A method as recited in claim 1, wherein said foraminous shield comprises plurality of screens.

11. A method as recited in claim 1, wherein the casting solution includes one of: polycarbonate, polyamide, polystyrene, polymethyl methacrylate, polyolefin, polysulfone, cellulose diacetate, cellulose triacetate, cellulose acetate propionate, cellulose acetate butyrate, bisphenol-A-polycarbonate, bisphenol-A-trimethylcyclohexane-polycarbonate, bisphenol-A-phthalate-polycarbonate, or norbornene resins.

12. A method as recited in claim 1, further comprising:
providing the casting solution over a front side of a casting band; and
applying heat to a backside of the casting band.

13. A method as recited in claim 12, further comprising:
disposing the casting band over two drums and applying heat to the drums.

14. A method as recited in claim 1, wherein the foraminous shield comprises a foraminous material having perforations with a size in a range approximately 0.1 mm to approximately 1.25 mm.

15. A method as recited in claim 13, wherein a percentage of a perforated area of the foraminous material to a non-perforated area of the shield is in the range of approximately 10 percent to approximately 65 percent.

16. A method as recited in claim 1, wherein the foraminous shield extends from a starting position of a drying zone on a casting surface, over a distance equal to approximately 20 percent to approximately 50 percent of a length of the drying zone.

17. A method as recited in claim 1, wherein the foraminous shield comprises a perforated plate material.

18. A method as recited in claim 1, further comprising:
removing the solvent at the location above the casting solution and from a bulk of the solution beneath the location at substantially the same rate.

19. An apparatus for drying a dope material, comprising
a casting surface adapted to have a casting solution disposed thereover; and
a foraminous shield disposed over the casting solution.

20. An apparatus as recited in claim 19, wherein the foraminous shield further comprises a layer of foraminous material.

21. An apparatus as recited in claim 19, wherein the foraminous shield comprises at least two layers of foraminous material.

22. An apparatus as recited in claim 20, wherein a distance between an upper surface of the casting solution and a lower surface of the layer of foraminous material is in the range of approximately 5.0 cm and approximately 1.0 cm.

23. An apparatus as recited in claim 21, wherein one of at least two layers of foraminous material is a bottom layer and a distance between an upper surface of the casting solution and a lower surface of the bottom layer of foraminous material is in the range of approximately 5.0 cm and approximately 1.0 cm.

24. An apparatus as recited in claim 19, wherein the foraminous shield comprises a perforated metal plate.

25. An apparatus as recited in claim 19, wherein the foraminous shield comprises a framework containing metal wire screens.

26. An apparatus as recited in claim 19, further comprising a drying stage, which includes the foraminous shield; and at least one other drying stage.

27. An apparatus as recited in claim 19, wherein the casting solution includes one of: polycarbonate, polyamide, polystyrene, polymethyl methacrylate, polyolefin, polysulfone, cellulose diacetate, cellulose triacetate, cellulose acetate propionate, cellulose acetate butyrate, bisphenol-A-polycarbonate, bisphenol-A-trimethylcyclohexane-polycarbonate, bisphenol-A-phthalate-polycarbonate, or norbornene resins.

28. An apparatus as recited in claim 19, wherein the casting surface includes a frontside and a backside, and the apparatus further comprises a heat source, which applies heat to a backside of the casting surface.

29. An apparatus as recited in claim 19, further comprising drums over which the casting surface is disposed.

30. An apparatus as recited in claim 19, wherein the foraminous shield comprises a foraminous material having perforation with a size in a range of approximately 0.1 mm to approximately 1.25 mm.

31. An apparatus as recited in claim 30, wherein a percentage of a perforated area of the shield to a non-perforated area of the foraminous material is in the range of approximately 10 percent to approximately 65 percent.

32. An apparatus as recited in claim 1, wherein the foraminous shield extends from a starting position of a drying zone on a casting surface, over a distance equal to approximately 20 percent to approximately 50 percent of a length of the drying zone.

33. An apparatus as recited in claim 19, wherein the foraminous shield includes portions on edges of the shield, and the edges extend toward the casting surface.

34. An apparatus as recited in claim 19, wherein the casting surface is a casting band.

35. An apparatus as recited in claim 19, wherein the casting surface is an outer surface of a casting wheel.

36. An apparatus as recited in claim 19, wherein the casting surface is a discontinuous substrate.
